(19) United States
(12) Patent Application Publication
(10) Pub. No.: US 2014/0262268 A1
(43) Pub. Date: Sep. 18, 2014

(54) Drilling and Completion Applications of Magnetorheological Fluid Barrier Pills

(71) Applicant: HALLIBURTON ENERGY SERVICES, INC. ("HESI"), Duncan, OK (US)

(72) Inventor: Paul Leon KAGELER, Lake Jackson, TX (US)

(73) Assignee: Halliburton Energy Services, Inc. ("HESI"), Duncan, OK (US)

(21) Appl. No.: 13/841,868

(22) Filed: Mar. 15, 2013

(51) Int. Cl. C09K 8/40; E21B 33/134

(52) U.S. Cl. CPC C09K 8/40; E21B 33/134
USPC 166/292; 166/192; 166/66.5

(57) ABSTRACT

A well apparatus including a magnetic field source positioned in a borehole and a magnetorheological fluid that forms a barrier pill proximate to the magnetic field source where the barrier pill formation isolates one well zone from another well zone. The apparatus may be used to define a treatment or cementation zone. A method for utilizing the apparatus for creation or maintenance of a well includes introducing a magnetorheological fluid into a borehole, forming a downhole barrier pill by providing a magnetic field source proximate to the fluid, and isolating one well zone from another well zone.

### BACKGROUND

Treatment fluids can be employed in a variety of subterranean operations. As used herein the terms “treatment,” “treating,” other grammatical equivalents thereof refer to any subterranean operation that uses a fluid in conjunction with performing a desired function and/or for achieving a desired purpose. The terms “treatment,” “treating,” and other grammatical equivalents thereof do not imply any particular action by the fluid or any component thereof. Illustrative subterranean operations that can be performed using treatment fluids can include, for example, drilling operations, fracturing operations, sand control operations, gravel packing operations, acidizing operations, conformance control operations, fluid diversion operations, fluid blocking operations, and the like.

It is a common practice to temporarily isolate wellbore zones during the drilling and completion of wellbores. The temporary isolation can be achieved by a mechanical device such as a casing valve, work string valve, or packer or by positioning a fluid barrier pill of suitable properties. Based on the specific application, the barrier pill may or may not be designed to transmit pressure. Examples of barrier pill fluids include thermoset fluids, time set fluids, highly thixotropic fluids, and high viscosity fluids. The barrier pill fluid is pumped into place and forms a static plug that temporarily isolates a wellbore zone with respect to mass transfer. When there is no longer a need for zone isolation; the barrier pill is removed by drilling through, rotating and washing through, and/or by displacing with another fluid. The barrier pill fluid can be incorporated into the drilling or completion fluid or circulated out of the wellbore and isolated for discharge, disposal, or reuse.

Once a traditional barrier pill is placed downhole, its rheological properties usually cannot be changed without removing and replacing the barrier pill with one of a different composition. This may require additional operating time and expenses due to the required barrier pill removal and replacement procedures. Therefore, a need exists for barrier pill with rheological properties that may be altered while the barrier pill is downhole.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 shows an illustrative example of an apparatus using a magnetorheological fluid barrier pill for tripping out a wellbore during managed pressure drilling operations.

FIG. 2 shows an illustrative example of an apparatus using a magnetorheological fluid barrier pill for supporting cement during curing.

FIG. 3 shows an illustrative example of an apparatus using a magnetorheological fluid barrier pill for preventing fluid loss after a wellbore filter cake is broken during acid treatment.

FIG. 4 shows an illustrative example of an apparatus using a magnetorheological fluid barrier pill for temporary isolation of the upper and lower completion zones in a wellbore.

FIG. 5 shows an illustrative example of an apparatus using a magnetorheological fluid barrier pill for controlling fluid losses.

FIG. 6 shows an illustrative example of deploying a retrievable apparatus using a magnetorheological fluid barrier pill for preventing fluid loss after a wellbore filter cake is broken.

FIG. 7 shows an illustrative example of a deployed and energized retrievable apparatus using a magnetorheological fluid barrier pill for preventing fluid loss after a wellbore filter cake is broken.

### DETAILED DESCRIPTION

The present invention generally relates to the use of magnetorheological fluids in subterranean operations, and, more specifically, to the use of magnetorheological fluid barrier pills and methods of using these fluids in various wellbore zones during subterranean operations.

A novel use of magnetorheological fluids is to form barrier pills for down hole applications. Magnetorheological fluids contain magnetic particles that are suspended in a carrier fluid. The carrier fluid can be oil or water-based including natural hydrocarbon oils, synthetic hydrocarbon oil, silicone oil, fresh water, and brines. Additives such as surfactants, viscosifiers, and/or suspension agents may or may not be added to prevent settling and/or to minimize co-mingling of fluids during the placement step. When a magnetorheological fluid is subjected to a magnetic field, it is possible to increase the apparent viscosity to the extent that a viscoelastic solid plug can be formed. Subjection to the magnetic field is commonly referred to as the “on position” and the absence of a magnetic field is referred to as the “off position.” In some embodiments, the rheological properties manifested in the “on and off positions” are both quickly and completely reversible. The yield strength per length of the plug coverage can be controlled by changing parameters such as the concentration of magnetic particles, the strength of the magnetic field, the concentration of various additives, and the gap width of the magnetic field. In certain embodiments, the downhole yield strength of the barrier pill in the “on position” can also be increased by increasing the length of wellbore coverage. In an embodiment, the barrier pill can also seal off when penetrated by a static work or drill string. In some embodiments, a barrier pill can also completely or partially seal off when penetrated by a rotating string and/or when penetrated by a sting being moved in or out of the wellbore. In one embodiment, the electromagnetic assembly is permanently installed. In another embodiment, the electromagnetic assembly is retrievable. In further embodiments, the electromagnetic assembly may be of a narrow gap design or broad gap design.

Another advantage of magnetorheological barrier pill fluids is that a carrier fluid can frequently be selected that is compatible with the drill or completion fluid and with the formation fluids. Drilling fluids are commonly referred to as “mud” and can be a Water Based Mud (WBM), an Oil Based Mud (OBM), or a Synthetic Based Mud (SBM). In some embodiments, by matching the carrier fluid of the barrier pill to the base fluid of the “mud,” the tubular walls can be wetted allowing for a more complete seal and co-mingling of barrier pill fluid into the “mud” at the interface will not adversely affect the performance of the “mud.” In certain embodiments, the leak off of the barrier pill into a reservoir formation will not cause excessive damage to the formation if the carrier fluid is properly selected.

The magnetorheological fluid may be formulated to achieve desired properties in the energized and de-energized states. For the non-energized state in certain embodiments, the magnetorheological fluid may be formulated to create a thixotropic fluid with rheological properties similar to drilling fluids. In various embodiments, the desired thixotropic properties may be achieved by adding suspension agents, viscosifiers, and dual purpose additives that increase both suspension and viscosity. In some embodiments, these viscosifiers and suspension agents include various natural and synthetic polymers and inorganic additives commonly used in drilling fluids. Some examples include but are not limited to xanthan gum, hydroxyethyl cellulose (HEC), bentonite, magnesium silicate, organophilic clay, diutan, and starches. In some embodiments, at high shear rates, such as during pumping or vigorous agitation, the viscosity decreases, allowing the fluid to be transferred without excessive pressure drop or to facilitate blending in an agitated vessel or pit with other components. At lower shear rates, such as when the de-energized fluid is in a static pill pit or transfer lines, excessive settling of solids may be prevented by higher viscosities and by interactions between the liquid and solids. In some embodiments, once the fluid is placed at the desired depth in the wellbore and pumping is stopped, the increase of viscosity inhibits mixing at the interfaces with other wellbore fluids. In certain embodiments for the energized state, the magnetorheological fluid may be formulated to create a gelatinous, semi-solid, or ridged plug across the sealing gap. For gelatinous and semi-solid energized plugs with elasticity, the plug may transmit hydrostatic pressure down the wellbore minimizing the differential pressure across the plug. For ridged energized plugs, the differential pressure across the plug may include the hydrostatic pressure exerted by the fluid column above the plug.

Completion fluids are usually low viscosity solids free brines with a variety of additives. Completion fluids are commonly formulated to a desired density and to minimize the potential for formation damage in the reservoir. In several embodiments, it is possible to select a barrier pill carrier fluid, such as a brine or fresh water, which will not compromise the performance of the completion fluid when mixing occurs at the interface.

In certain embodiments, the dual characteristics, properties, and flexibility in composition make magnetorheological fluids a good option to function as a “liquid valve” in downhole temporary isolation applications. In some applications, a magnetorheological barrier pill “liquid valve” is an alternative to a mechanical casing valve, a packer, a reservoir isolation valve, or a work string fluid isolation valve. In various embodiments, some of the potential advantages as compared to mechanical valves include tolerance to debris, seal off in both directions, transmission of pressure when desired, simplicity, flexibility in depth, and the ability to seal off when a work string extends through a “turned on” barrier pill. Desired characteristics of a barrier pill include stable suspension of magnetic solids, thixotropic rheology, desired density, ability to wet tubular walls, and compatibility with other wellbore fluids. In some embodiments, additives that create a highly thixotropic fluid such as magnesium silicate for isolating fluid motion may help enhance barrier pill performance in applications where a work or drill string is being rotated or moved while extending through a “turned on” barrier pill.

Within the magnetorheological fluid the magnetic component may be any magnetic components, including ferromagnetic components. One of skill in the art would know that the amount of the magnetic components in the magnetorheological fluid will likely influence how much the viscosity and yield strength increase from a de-energized state to an energized state. Hence, fluids with a higher content of magnetic components generally have higher viscosities and yield strengths in the energized state than fluids with lower content of the same magnetic components in the energized state. However, the type of magnetic component as well as the amount of the magnetic component may both influence the degree of the increase in viscosity when the fluid is energized. In illustrative embodiments, the amount of the magnetic component is selected such that an expected increase in viscosity is achieved. In certain embodiments, the amount and type of magnetic components are selected so that a gelatinous or semi-solid plug is formed at a given magnetic field intensity. In other embodiments, a ridged solid plug of high yield strength forms at a given magnetic field intensity. In some embodiments, the magnetic field applied has an intensity in the range of about 0.01 to about 1.0 Tesla.

There are several configurations for the down hole electromagnetic assembly. The configurations include permanent and retrievable assemblies. In some retrievable assembly embodiments, the depth of retrievable electromagnetic assemblies may be quickly adjusted by a wire line bundle that supports the assembly from the top of the wellbore, provides power through a power cable in the wire line bundle, and the power is controlled from the surface. In one embodiment, the retrievable electromagnetic assembly suspended from a wire line bundle may be lowered through a work string in a compact or folded configuration until clear of the bottom of the work string and then expanded outward towards the wellbore walls in the annulus. Another embodiment is an “Electromagnetic Liquid Casing Valve” configuration that is integrated into the casing and is activated by a power cable run down from the surface on the outside diameter of the casing. In some embodiments, downhole temperatures greater than 200° C. are possible and the valve can be “turned on” for extended time periods and quickly controlled from the surface. A further embodiment is a “Liquid Packer” configuration that includes the electromagnets and lithium thionyl chloride battery packs. Downhole temperatures are limited to less than 200° C. In certain embodiments, the packer can be retrievable or permanent. The battery pack size determines the length of time that the electromagnetics can be “turned on” and a downhole signal such as a pressure cycle is necessary to turn the power “on and off.” In some embodiments, the “Liquid Packer” configuration offers the flexibility to select the position in the cased wellbore. In a further embodiment, the “Liquid Fluid Isolation Valve” configuration is mounted on a work string. In some embodiments, the work string is stabbed into a packer and then used to isolate an upper zone from a lower zone. In certain embodiments, the “Electromagnetic Liquid Fluid Isolation Valve” configuration includes lithium thionyl chloride battery packs and operates similarly to the “Liquid Packer” configuration.

In illustrative embodiments, a well apparatus includes a magnetic field source positioned in a borehole and a magnetorheological fluid that forms a barrier pill proximate to the magnetic field source, where the magnetic field source is positioned such that the formed barrier pill isolates one well zone from another well zone. In some embodiments the device may include a tubular string having an inner or outer surface that contacts the barrier pill. In an embodiment, the magnetic field source is an electromagnet. In further embodiments, the electromagnet is integrated into a tubular string, with the tubular string including at least one of a casing string, a work string, and a drill string. A preferred embodiment for the tubular string includes at least one of a casing string and a work string.

In further embodiments, the tubular string includes a work string with a by-pass circulation valve that facilitates placement of the magnetorheological fluid. In one embodiment, the by-pass valve by-pass valve “sub” that can be installed into a drill string or work string. An example of a by-pass valve useful in the invention is the Clean Well™ Turbo Tech™, available from Wellbore Energy Solutions, LLC.

In illustrative embodiments, the electromagnet is powered by a downhole source including at least one of a generator and a battery. In certain embodiments, the electromagnet is powered from the surface via an electrical conductor. In another embodiment, the electromagnet is integrated into a packer.

In some embodiments, the barrier pill defines a treatment or cementation zone. In other embodiments, the barrier pill separates two completion zones. In a further embodiment, the barrier pill isolates a fluid loss zone.

Certain embodiments of the invention are also directed to a well creation or maintenance method that includes introducing a magnetorheological fluid into a borehole, forming a downhole barrier pill by providing a magnetic field source proximate to the fluid, and isolating one well zone from another well zone. In some embodiments, the providing includes energizing an electromagnet as said magnetic field source. In another embodiment, the energizing comprises supplying power from at least one downhole source in the group consisting of a generator and a battery pack. In an embodiment, the energizing is triggered by applying a downhole pressure cycle. In a further embodiment, the energizing includes supplying power from the surface via an electrical conductor. In various embodiments, introducing includes opening a bypass valve in a tubular string to circulate the magnetorheological fluid to a desired position.

In some embodiments, the creation or maintenance method includes positioning the fluid to define at least one end of a completion, treatment, or cementation zone. In other embodiments, positioning the fluid to isolate a fluid loss zone is carried out. Further embodiments include adding a mud fluid cap in a casing string above the barrier pill. Yet another embodiment includes forming a cement plug by introducing a cement slurry pill into a position above the barrier pill. An additional embodiment is directed to treating a treatment zone by circulating a treatment fluid above the barrier pill.

An illustrative example of an apparatus for a tripping out of a wellbore application during managed pressure drilling is shown by FIG. 1. Several electromagnets 102 are included in the casing assembly 104 with a multiple wire power cable 106 installed down the outside diameter of the casing 108. The drill string is pulled up to the bottom of the lowest electromagnet 110 as the bottom hole pressure is controlled by a managed pressure drilling system 112. A magnetorheological fluid barrier pill 114 is placed by pumping down the drill string 113 into the annulus. In certain embodiments, the magnetorheological fluid contains additives to suspend the electromagnet particles and to achieve an adequate “turned off” apparent viscosity to prevent co-mingling of fluids during the placement and removal steps. In some embodiments, the managed pressure drilling system 112 is used to control bottom hole pressure during the entire barrier pill placement step and later when the barrier pill 114 is being circulated out of the wellbore. In various embodiments, as the barrier pill 114 enters the annulus, a pump and pull technique is used such that the bit (not shown) is always covered by the “turned off” barrier pill 114 and turbulence below the barrier pill in the open hole section 118 is minimized. When the bit is above the top of lowest electromagnet 110, that electromagnet 104 is “turned on” to further minimize co-mingling of fluids below the bit. In certain embodiments, the current is adjusted such that the “turned on” magnetorheological fluid still allows transmission of pressure. The pump and pull procedure is continued with additional electromagnets 104 being “turned on” until a stand of drill pipe must be disconnected and racket back. In some embodiments, during the disconnection, the downhole pressure is controlled by pumping across the top of the wellbore or by trapping pressure. Once the entire barrier pill 114 has been placed into position, the bit is pulled completely out of the barrier pill 114 and mud cap fluid 116 that is of greater density than the drilling fluid is pumped into position. Once the mud cap 116 is in place and the wellbore has sufficient static hydraulic pressure, the drill string is tripped out of hole without managing the downhole pressure. The flow of current to the electromagnets 106 may or may not be increased to form a stronger barrier pill 114 to help prevent migration of gas up the wellbore. When tripping back into the wellbore for drilling forward or to initiate the next step, the drill or work string is first tripped down to the top of the barrier pill 114. The barrier pill 114 is then “turned off” and the string tip is moved down to the bottom of the barrier pill. Next, the managed pressure drilling system 112 is activated to control bottom hole pressure, and the mud cap 116 and barrier pill 114 are then circulated out of the wellbore with drilling fluid. In some embodiments, the displaced barrier pill 114 is incorporated into the drilling fluid. In other embodiments, the returned barrier pill 114 is collected in a pit for reuse, discharge, or disposal.

An example of supporting cement in a wellbore during curing is shown by FIG. 2. In an embodiment, a retrievable packer 206 with electromagnets 204 and lithium thionyl chloride battery packs 208 is run into the wellbore to the desired depth and set in position. The work string 213 is pulled up to the bottom of the electromagnet 210. A magnetorheological fluid pill 214 is placed by pumping down 212 the work string 213 into the annulus. In some embodiments, the magnetorheological fluid contains additives to suspend the electromagnet particles and to achieve an adequate “turned off” apparent viscosity to prevent co-mingling of fluids during the placement and removal processes. In an additional embodiment, as the barrier pill 214 enters the annulus, a pump and pull technique is used such that the work string tip is always covered by the “turned off” barrier pill 214 and turbulence below the barrier pill is minimized. Once the entire barrier pill 214 has been placed into position, the work string 213 is pulled completely out of the barrier pill 214 and the electromagnet 204 is “turned on” by cycling the pressure. The “turned on” barrier pill 214 forms a strong plug. The cement pill 216 is then circulated into position and the work string flushed out. The wellbore remains static until the cement has cured into a strong plug 216. In one embodiment, the barrier pill 214 is “turned off” once the energy of the battery pack 208 is depleted. When the cement plug 216 needs to be removed, a drill string is used to drill out the plug 216, the “turned off” barrier pill 214 is circulated out of the wellbore, and a retrieval tool is then used to remove the packer 206 from the wellbore. If desired, a permanent packer can be used and left in the wellbore. In some embodiments, the returned barrier pill 214 is caught in a pit for discharge, disposal, or reuse. Using a barrier pill for setting a cement plug is possible during drilling or completions. In another embodiment, it is also possible to “turn off” the electromagnet by cycling the pressure if the battery pack still has energy.

Several examples of enhancing acid breaking treatment by reducing the rate of leak-off are shown by FIGS. 3, 6, and 7. FIG. 3 shows a permanent electromagnet mounted on the casing, and FIGS. 6-7 show a retrievable electromagnet suspended by a wire line bundle and expanded in the annulus. An example of acid breaking treatment fluid is N-FLOW™, available from Halliburton Energy Services. A work string 312 is run to bottom of hole after the reservoir has been drilled with BARADRIL-N™ fluid, available from Halliburton Energy Services. An N-FLOW pill 318 is pumped into position using a pump and pull technique. After all the N-FLOW pill 318 is positioned, the work string 312 is pulled up to the bottom 310 of the electromagnet 304. A magnetorheological fluid pill 314 is placed by pumping down the work string 312 into the annulus. In some embodiments, the magnetorheological fluid contains additives to suspend the electromagnet particles and to achieve an adequate “turned off” apparent viscosity to prevent co-mingling of fluids during the placement and removal steps. In certain embodiments, as the barrier pill 314 enters the annulus, a pump and pull technique is used such that the work string tip is always covered by the “turned off” barrier pill and turbulence below the barrier pill is minimized. Once the entire barrier pill 314 has been placed into position, the work string 312 is pulled completely out of the barrier pill 314 and the electromagnet 304 is “turned on” using the power cable 306. The “turned on” barrier pill 314 quickly forms a strong plug. The N-FLOW pill 318 generates acidity that removes the wellbore filter cake. As holes are opened through the filter cake, isolation from the cased wellbore prevents the rapid loss of acidic solution allowing for an even treatment along the entire reservoir wellbore.

An example of isolating upper and lower completion zones is shown by FIG. 4. A production packer 406 is installed above the zone to be isolated. A work string is run through the center of the packer and gravel pack 418 is installed in the lower zone. In an embodiment, a work string 412 with an “Electromagnetic Liquid Fluid Isolation Valve” 403 and a by-pass valve 402 is tripped in and stabbed into the packer center opening to form a seal. The work string 412 is then lifted up to break the seal. A magnetorheological fluid pill is placed by pumping the barrier pill 414 down the work string 412. A pressure cycle is used to “turn on” the electromagnet 404. The barrier pill 414 located inside the work string 412 forms a strong plug. The work string tip 412 is stabbed back into the packer center hole isolating the upper 410 and lower 418 completions. In some embodiments, the upper completion 410 can be circulated using the by-pass valve 402. To un-isolate the two completion zones; the work string 412 is picked-up, the electromagnet 404 is “turned off,” the barrier pill 414 is circulated out of the wellbore, and the work string 412 is stabbed back into the packer 406.

An example of controlling fluid losses is shown by FIG. 5. A drill string 512 with a by-pass valve 502 is used to drill forward. The drill bit enters a depleted or fragile formation and fluid losses start. A magnetorheological fluid barrier pill 514 is pumped through the by-pass valve 502 and allowed to move down the annulus as the trip tank is monitored and refilled. When the barrier pill 514 is positioned; the electromagnet 504 is “turned on,” the barrier pill 514 forms a strong plug around the drill string, the by-pass valve 502 is closed, and fluid 508 is pumped in the drill string 512 to maintain a desired pressure. Lower density drilling fluid is prepared in the pits and Loss Control Material (LCM) 516 is pumped down the drill string 512 to reduce or stop fluid losses. The upper zone is displaced with the lower density drilling fluid 510. In some embodiments this is accomplished by opening the by-pass valve 502. Then, the bypass valve 502 is closed, the electromagnet 504 is “turned off,” and the lower density drilling fluid is pumped down the annulus until the entire wellbore has been displaced. The wellbore is monitored and if static, drilling forward is resumed.

An additional example of enhancing acid breaking treatment by reducing the rate of leak-off is shown by FIGS. 6-7. In one embodiment, a retrievable electromagnet suspended by a wire line bundle and expanded in the annulus. FIG. 6 shows one embodiment of the deployment of the expandable electromagnetic assembly. FIG. 7 shows an expanded and energized electromagnetic assembly. An example of acid breaking treatment fluid is N-FLOW™. A work string 612,712 is run to bottom of hole after the reservoir has been drilled with BARADRIL-N™ fluid. An N-FLOW pill 618,718 is pumped into position using a pump and pull technique. After all the N-FLOW pill 618,718 is positioned, the work string 612,712 is pulled up to the bottom 610,710 of the electromagnet 604,704. A magnetorheological fluid pill 614,714 is placed by pumping down the work string 612,712 into the annulus. In some embodiments, the magnetorheological fluid contains additives to suspend the electromagnet particles and to achieve an adequate “turned off” apparent viscosity to prevent co-mingling of fluids during the placement and removal steps. In certain embodiments, as the barrier pill 614,714 enters the annulus, a pump and pull technique is used such that the work string tip is always covered by the “turned off” barrier pill and turbulence below the barrier pill is minimized. Once the entire barrier pill 614,714 has been placed into position, the work string 612,712 is pulled completely out of the barrier pill 614,714 and the expandable electromagnet 604,704 is lowered in the work string 612,712 below the end of the work string and into the barrier pill 614,714. The electromagnet 604,704 is then expanded toward the inside surface of the casing string and “turned on” using the power cable 606,706. The “turned on” barrier pill 614,714 quickly forms a strong plug. The N-FLOW pill 618,718 generates acidity that removes the wellbore filter cake. As holes are opened through the filter cake, isolation from the cased wellbore prevents the rapid loss of acidic solution, allowing for an even treatment along the entire reservoir wellbore. Upon completion of the breaking treatment, the electromagnet 604,704 may be compressed and pulled up to the surface through the work string 612,712, using wire line and power cable 606,706.

When appropriate, any suitable fluid loss control materials known in the art may be used, for example polymer fluid loss control additives, particulate fluid loss control additives, or combinations thereof. In an embodiment, the fluid loss control additive may comprise one or more starches. Such starches may be the same or different; used as an LPM as a fluid loss additive or both; and may be used alone or in combination with another LPM, fluid loss control additive, or both. In an embodiment, the fluid loss control additives may comprise, for example, natural and/or derivatized polysaccharides like galactomannan gums (guar gum, guar derivatives, etc), biopolymers, modified celluloses or combinations thereof in addition to or in lieu of the fluid loss control additives listed above.

One of skill in the art will ascertain that magnetorheological fluids offer distinct advantages such a fast and fully reversible change in rheological properties, strong plug formation, and flexibility in selecting carry fluid.

The exemplary magnetorheological fluids, apparatuses, and methods utilizing such fluids disclosed herein may directly or indirectly affect one or more components or pieces of equipment associated with the preparation, delivery, recapture, recycling, reuse, and/or disposal of the disclosed magnetorheological fluids. For example, the disclosed magnetorheological fluids may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary magnetorheological fluids. The disclosed magnetorheological fluids may also directly or indirectly affect any transport or delivery equipment used to convey the magnetorheological fluids to a well site or downhole such as, for example, any transport vessels, conduits, pipelines, trucks, tubulars, and/or pipes used to fluidically move the magnetorheological fluids from one location to another, any pumps, compressors, or motors (e.g., topside or downhole) used to drive the magnetorheological fluids into motion, any valves or related joints used to regulate the pressure or flow rate of the magnetorheological fluids, and any sensors (i.e., pressure and temperature), gauges, and/or combinations thereof, and the like. The disclosed magnetorheological fluids may also directly or indirectly affect the various downhole equipment and tools that may come into contact with the chemicals/fluids such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

### EXAMPLES

One example of a method for temporarily isolating an upper and lower completion zone includes: providing a wellbore comprising a well casing, a string, a by-pass valve on the string, an electromagnetic assembly mounted on the string, and a packer with a hole, wherein the packer is located in the wellbore above a zone to be isolated, and the electromagnet assembly comprises at least one electromagnet; tripping in the string and stabbing the string into the hole in the packer to form a seal; lifting the string to break the seal; introducing a treatment fluid into the string with the by-pass valve closed, wherein the treatment fluid comprises a magnetorheological component; receiving a downhole signal to energize or de-energize the electromagnetic assembly; inducing a change in the rheological properties of the treatment fluid by energizing or de-energizing at least one electromagnet in the electromagnetic assembly; and stabbing the tip of the string into the packer hole, thereby isolating one zone of the wellbore from another zone using the treatment fluid.

In some embodiments the method additionally includes opening the by-pass valve and circulating completion fluid through the string into the upper zone. Another embodiment further includes picking up the string, de-energizing the electromagnetic assembly, circulating the treatment fluid out of the wellbore, and stabbing the work string into the packer.

In yet another embodiment the method additionally includes delivering gravel pack to a zone below the packer through a string before introducing the treatment fluid, and removing the string if it does not contain a by-pass valve and an electromagnetic assembly, wherein the string has been run through the center of the packer into the zone to be isolated.

An example of the preparation and deployment of an aqueous magnetorheological fluid at a drill site is as follows:

Water is added to an agitated pill pit. The pill pit is agitated and circulated. Powdered viscosifiers/suspension agents are added through a powder hopper and mixed in an eductor with circulated fluid. The pill pit is agitated and circulated until the viscosifiers/suspension agents are fully hydrated. Surfactants, wetting, and de-foaming agents are added through the top of the agitated pill pit. The magnetorheological component is added through the top of the agitated pill pit and evenly dispersed throughout the pit. The magnetorheological pill is pumped from the pill pit to a charger pump that feeds a triplex reciprocating plunger pump referred to as the mud pump. The mud pump transfers the magnetorheological pill into the work string or drill string. The mud pump feed is changed to drilling fluid. While totalizing the strokes of the mud pump, the magnetorheological pill is displaced from the work string or drill string with drilling fluid into to the annulus. Once the entire magnetorheological pill is in the annulus, the pumping is stopped, the work or drill string pulled above the magnetorheological pill, and the electromagnet is activated.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A well apparatus comprising:
a magnetic field source positioned in a borehole; and
a magnetorheological fluid that forms a barrier pill proximate to the magnetic field source; wherein said magnetic field source is positioned such that the formed barrier pill isolates one well zone from another well zone.

2. The well apparatus of claim 1, further comprising a tubular string having an inner or outer surface that contacts said barrier pill.

3. The well apparatus of claim 1, wherein the magnetic field source is an electromagnet.

4. The well apparatus of claim 3, wherein the electromagnet is integrated into a tubular string, with the tubular string comprising at least one of a casing string and a work string.

5. The well apparatus of claim 4, wherein the tubular string comprises a work string with a by-pass circulation valve that facilitates placement of the magnetorheological fluid.

6. The well apparatus of claim 4, wherein the electromagnet is powered by a downhole source comprising at least one of a generator and a battery.

7. The well apparatus of claim 3, wherein the electromagnet is powered from the surface via an electrical conductor.

8. The well apparatus of claim 3, wherein the electromagnet is integrated into a packer.

9. The well apparatus of claim 1, wherein the barrier pill defines a treatment or cementation zone.

10. The well apparatus of claim 1, wherein the barrier pill separates two completion zones.

11. The well apparatus of claim 1, wherein the barrier pill isolates a fluid loss zone.

12. The well apparatus of claim 1, wherein the magnetic field source is suspended by and powered from a wire line bundle and is retrievable.

13. The well apparatus of claim 12, further comprising a casing string and a work string, wherein the magnetic field source has a compact configuration and an expanded configuration, wherein the compact configuration may be lowered through the work string in a configuration of reduced diameter, wherein the expanded configuration has a diameter larger than the inside diameter of the work string, but smaller than or equal to the inside diameter of the casing string.

14. A method comprising:
introducing a magnetorheological fluid into a borehole;
forming a downhole barrier pill by providing a magnetic field source proximate to the fluid; and
isolating one well zone from another well zone.

15. The method of claim 14, wherein said providing includes energizing an electromagnet as said magnetic field source.

16. The method of claim 15, wherein said energizing comprises supplying power from at least one downhole source in the group consisting of a generator and a battery pack.

17. The method of claim 16, wherein said energizing is triggered by applying a downhole pressure cycle.

18. The method of claim 14, wherein said energizing comprises supplying power from the surface via an electrical conductor.

19. The method of claim 14, wherein said introducing includes opening a by-pass valve in a tubular string to circulate the magnetorheological fluid to a desired position.

20. The method of claim 14, further comprising: positioning said fluid to define at least one end of a completion, treatment, or cementation zone.

21. The method of claim 14, further comprising: positioning said fluid to isolate a fluid loss zone.

22. The method of claim 14, further comprising adding a mud fluid cap in a casing string above the barrier pill.

23. The method of claim 14, further comprising forming a cement plug by introducing a cement slurry pill into a position above the barrier pill.

24. The method of claim 14, further comprising treating a treatment zone by circulating a treatment fluid above the barrier pill.

25. A method comprising:
providing a wellbore comprising a well casing, an electromagnetic assembly, and a string, wherein the electromagnet assembly comprises at least one electromagnet;
introducing a treatment fluid into the well casing or the string, wherein the treatment fluid comprises a magnetorheological component;
receiving a downhole signal to energize or de-energize the electromagnetic assembly;
inducing a change in the rheological properties of the treatment fluid by energizing or de-energizing at least one electromagnet in the electromagnetic assembly; and
isolating one zone of the wellbore from another zone using the treatment fluid.

26. The method of claim 25, wherein the inducing energizes or de-energizes the at least one electromagnet using at least one of a power cable and a battery pack.

27. The method of claim 25, wherein the treatment fluid becomes more viscous upon the energizing of the electromagnetic assembly.

28. The method of claim 25, wherein the downhole signal is a pressure cycle in the wellbore.

29. The method of claim 25, wherein the string is a work string.

30. The method of claim 25, further comprising providing a packer in the well casing between the two zones to be isolated, removing the string from the wellbore after the treatment fluid is energized, adding a cement pill into a position above the energized treatment fluid, and allowing a cement plug to form.

31. The method of claim 25, further comprising pumping an acid breaker pill down the string into a zone with a filter cake below the electromagnetic assembly and raising the string to the level of the at least one electromagnet, both pumping and raising occurring before introducing the at least one treatment fluid.

32. The method of claim 25, further comprising providing a by-pass valve on a portion of the string located in a zone above the electromagnetic assembly, wherein the string extends into the zone below the electromagnetic assembly; introducing the treatment fluid through the by-pass valve into the well casing annulus; closing the by-pass valve; energizing the electromagnetic assembly, and continuing to pump drilling fluid through the drill string into the lower zone.
